(19) United States
(12) Patent Application Publication
(10) Pub. No.: US 2006/0192881 A1
(43) Pub. Date: Aug. 31, 2006

(54) Display apparatus, camera, and display method

(76) Inventors: Kazuhiro Sato, Sagamihara-shi (JP); Kensei Ito, Sagamihara-shi (JP); Takashi Fujii, Sayama-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/364,625

(22) Filed: Feb. 28, 2006

(30) Foreign Application Priority Data
Feb. 28, 2005 (JP) 2005-052779
Jan. 18, 2006 (JP) 2006-009519

(51) Int. Cl. H04N 5/222

(52) U.S. Cl. 348/333.05

(57) ABSTRACT

A display apparatus of the present invention has a display section for displaying a plurality of groups of images on the same screen on a group basis. The display apparatus allows a user to select a desired group from the plurality of groups with the operation of a selection instruction section. When the user instructs image switching, only the images in the selected group is switched. Thus, the user can retrieve a target image efficiently from the groups of images managed on a group basis.

### CROSS-REFERENCE TO RELATED APPLICATION

This application is based upon and claims the benefit of priority from prior Japanese Patent Application Nos. 2005-052779, filed on Feb. 28, 2005; and 2006-009519, filed on Jan. 18, 2006, the entire contents of which are incorporated herein by reference.

### BACKGROUND OF THE INVENTION

1. Field of the Invention

This invention relates to display control technology for image retrieval suitable for electronic devices such as a digital camera and a PDA (Personal Digital Assistant).

2. Description of the Related Art

Digital cameras using semiconductor devices such as CCDs (Charge Coupled Devices) to capture subject images have recently become widespread. Recording media for image storage, incorporated in or removably loaded into cameras of this type, continue to increase in capacity. As the recording media increase in capacity, the number of images recordable on a recording medium increases enormously. For example, if the image quality is of medium quality, about 1000 still images can be recorded on a 500-MB recording medium. With the increase in the number of recordable images, the retrieval of images becomes an issue.

As a typical technique for image retrieval, there is a method of sequentially displaying a group of small images, so-called thumbnail images. In general, nine images is collectively displayed per screen in a pattern of three horizontal rows and three vertical columns in order of shooting date and time with consideration given to the display area of the LCD on the back of the camera. In this case, a user operates a control button to switch the display images to retrieve a desired image.

Instead of collectively managing image shots recorded on a medium in order of shooting date and time, there is another method of retrieving a desired image, in which images recorded are classified beforehand into a plurality of groups to display images on a group basis when the user retrieves the desired image (for example, see Japanese Patent Laid-Open No. 2002-211049). In this case, since images are classified into some groups, this results in a reduction in the number of display images at the time of image retrieval. Therefore, it is expected to reduce the retrieval time.

As mentioned above, if images stored on a recording medium are classified into some groups, for example, on a category or shooter (camera operator) basis, and managed on a group basis, image groups, each consisting of small images, can be displayed in order, allowing the user to find a desired image in a shorter time.

However, as the number of kinds of groups increases, image retrieval could require more time unless the user can identify a group to which a target image belongs. In other words, if the user cannot identify the group name registered in the camera displaying images on a group basis as mentioned above, the user has no other choice but to call up possible groups one by one to find the target image.

In such a case, grouping will be less help to the user.

The present invention has been made in view of the above-mentioned circumstances, and it is an object thereof to provide a display apparatus, a camera, and a display method, capable of retrieving a target image efficiently from image groups classified and managed on a group basis.

### BRIEF SUMMARY OF THE INVENTION

In order to attain the above object, according to a first aspect of the present invention, there is provided a display apparatus comprising: a display section for displaying images; a control section for causing a plurality of groups of images appear (to be displayed) simultaneously on the display section on a group basis while controlling the switching of images to be displayed on the display section; a switching instruction section for instructing the switching of images to be displayed on the display section; and a selection instruction section for selecting a group from the plurality of groups displayed on the display section. When the switching instruction section instructs switching, the control section switches only the images displayed as a group selected by the selection instruction section from all the images displayed on the screen in accordance with the instruction from the switching instruction section.

In the display apparatus according to the first aspect of the present invention, when the control section is switching the images displayed as the group selected by the selection instruction section in accordance with the instruction from the switching instruction section, if the switching instruction section instructs switching in response to the selection of a new group through the selection instruction section, the control section can continue the switching of images in the former group while starting the switching of images in the latter group separately from the former group.

The control section can also switch images as if to scroll a row of images while controlling at least either the scrolling speed or the scrolling direction independently on a group basis.

According to a second aspect of the present invention, there is provided a camera comprising: the display apparatus according to the first aspect of the present invention; and an imaging section for forming subject images, wherein the control section causes images formed by the imaging section to appear on the display section as grouped images.

According to a third aspect of the present invention, there is provided a display method for displaying on a display section images managed on a group basis, comprising: displaying a plurality of groups of images grouped and managed by each group on the same screen on a group basis; and when an instruction for switching images is accepted, only the images of the groups that is arbitrarily selected from the plurality of groups becomes the objects of the image switching in response to the instruction for switching images.

According to the present invention, there are provided a display apparatus, a camera, and a display method, capable of retrieving a target image efficiently from image groups classified and managed on a group basis.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a back view of a digital camera according to a first embodiment of the present invention;

FIG. 2 is a block diagram showing the structure of the camera according to the embodiment of the present invention;

FIG. 3 is a diagram showing an example of an image display screen when the camera is in an album mode according to the embodiment of the present invention;

FIG. 4 is a diagram showing a first specific example of the transition of the display screen when the camera is in the album mode according to the embodiment of the present invention;

FIG. 5 is a diagram showing a second specific example of the transition of the display screen when the camera is in the album mode according to the embodiment of the present invention;

FIG. 6 is a diagram showing a third specific example of the transition of the display screen when the camera is in the album mode according to the embodiment of the present invention;

FIG. 7 is a flowchart showing the flow of the main operation when the camera is in the album mode according to the embodiment of the present invention;

FIG. 8 is a flowchart showing a detailed procedure for group identification processing in the camera (in the album mode) according to the embodiment of the present invention;

FIG. 9 is a flowchart showing a detailed procedure for scrolling instruction processing in the camera (in the album mode) according to the embodiment of the present invention; and

FIG. 10 is a diagram showing a display example of an image monitor (medical image viewer) according to a second embodiment of the present invention.

### DETAILED DESCRIPTION OF THE PREFERRED EMBODIMENTS

A preferred embodiment of the invention is described below with reference to the accompanying drawings.

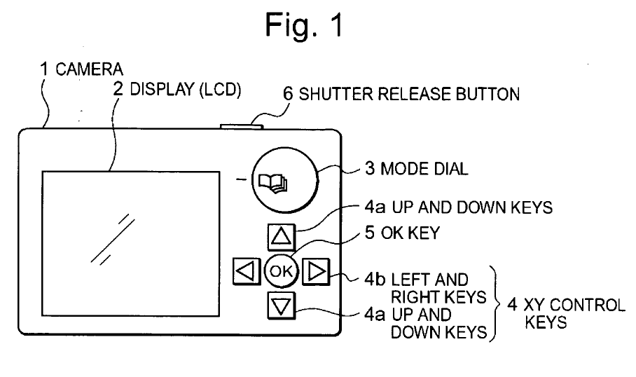

FIG. 1 is a back view of a digital camera 1 incorporating a display apparatus according to a first embodiment of the present invention.

As shown in FIG. 1, the display surface of a display 2 is arranged on the back of the camera 1. The display 2 is, for example, an LCD (liquid crystal display). Then, operation control elements, such as a mode dial 3, XY control keys 4 consisting of a pair of up and down keys 4a and a pair of left and right keys 4b, and an OK key 5, are arranged on the right side of the camera 1. Further, a shutter release button 6 is provided on the top of the camera 1.

A user rotates the mode dial 3 to set the operation mode of the camera 1. The camera 1 has a shooting mode for capturing images and a playback mode for displaying the images. The camera 1 also has an album mode as one form of the playback mode, which allows the user to view each group of images registered in the group at his or her discretion. Each group under which images are categorized and managed is also called an “album” below. In FIG. 1, the mode dial 3 is at a position indicating the album mode.

The XY control keys 4 are used to select an option from a plurality of options arranged in the vertical (column) direction on the display 2 (up and down keys 4a) and to select an option from a plurality of options arranged in the horizontal (row) direction on the display 2 (left and right keys 4b). In other words, the up and down keys 4a serve as a selection instruction section, while the left and right keys 4b serve as a switching instruction section. The OK key 5 is used to accept an option being selected using the XY control keys 4.

As mentioned above, the camera 1 has the album mode capable of displaying images on a group basis. In the album mode, a predetermined number of groups are displayed in the vertical (column) direction, while a predetermined number of images in each group are displayed in the horizontal (row) direction. The camera 1 of the embodiment can realize display control with dramatically improved efficiency of finding a target image from images arranged in a two-dimensional matrix in the album mode using the XY control keys 4 and the OK key 5. The shutter release button 6 is used to instruct recording of image data of a subject image shot by the user and displayed on the display 2 as a so-called monitor image.

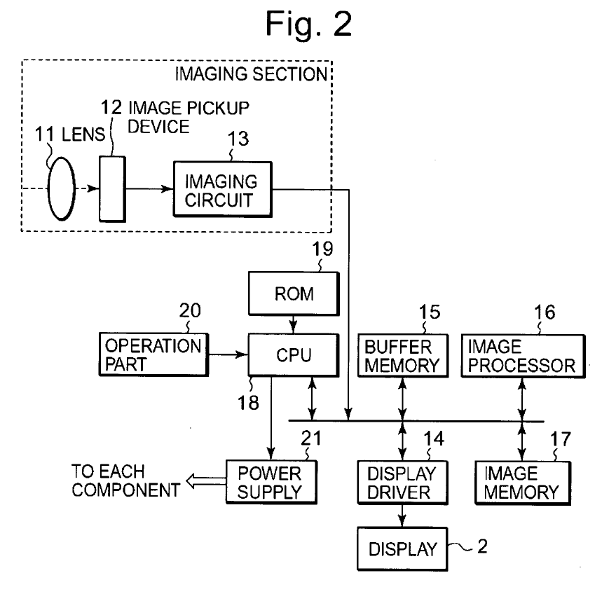

FIG. 2 is a block diagram showing the structure of the camera 1.

The camera 1 has an imaging section and a display apparatus as its functional blocks. The imaging section mainly consists of a lens 11, an image pickup device 12, and imaging circuit 13. The display apparatus mainly consists of a display 2, a display driver 14, an image processor 16, a CPU 18, a ROM 19, and an operation part 20.

When light of a subject image passing through the lens 11 is incident on the image pickup device 12, the subject image is formed on the imaging surface. The imaging circuit 13 performs various control on the image pickup device 12, such as exposure control and reading control, so that a picture signal on the image pickup device 12 is subjected to various processing, such as the setting of ISO-equivalent sensitivity, automatic white balance processing, luminance/color signal creation, and gamma processing, and is converted to a color picture signal in a predetermined format.

In a shooting mode, the color picture signal is transferred to the display driver 14 via a system bus, and displayed on the display 2 on the back of the camera 1 as a monitor image to allow the user to check the subject image.

Then, if the user presses the shutter release button 6, the color picture signal output from the imaging circuit 13 is captured in a buffer memory 15, compressed and encoded by the image processor 16, and recorded as an image shot in an image memory 17.

Upon playback including the album mode, the image shot recorded in the image memory 17 is read by the image processor 16, supplied to the display driver 14 after decompressed (expanded) and decoded, and displayed on the display 2.

The operation of the camera 1 as described above is integrally controlled by the CPU 18. A program describing the control procedure performed by the CPU 18 and various setting values as parameters to be passed on the program are stored in the ROM 19. Control signals from the operation part 20 are also supplied to the CPU 18. The operation part 20 detects and informs the CPU 18 of user's operations, such as operations of the mode dial 3, the XY control keys 4, the OK key 5, and the shutter release button 6. The CPU 18 also controls a power supply 21 for supplying operating power to each component.

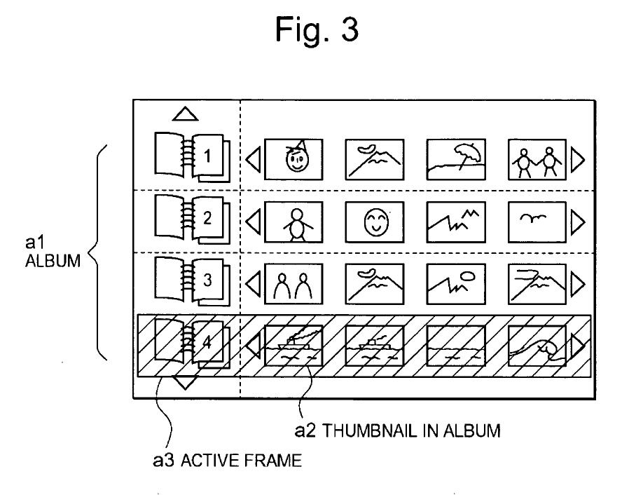

FIG. 3 is a diagram showing an example of an image display in the album mode. As shown, four groups are arranged in the vertical (column) direction (a1), and four images belonging to each group are arranged in the horizontal (row) direction (a2). Icons at the leftmost column indicate respective groups assigned group numbers, respectively. Note that the relationship between the row and column is just illustrative, and the row and column can be replaced with each other. Further, the number of groups and the number of images displayed on the same screen can be changed. The number of images displayed in each group can be one.

In the album mode in which the four groups are displayed on a single screen at a time, an active frame (a3) is also displayed, indicating which group is active (selected-state). In FIG. 3, the fourth group is active. In this state, if the up and down keys 4a in the XY control keys 4 are operated downward, the group rows are scrolled. To be specific, the current screen of the first to fourth group arrangement is switched to the second to fifth, third to sixth group arrangement each time the user pressed the down key as if the user scrolled down a page. On the other hand, when the left or right key 4b in the XY control keys 4 are operated, a row of images in a group with the active frame is moved as if the user scrolled a page to the left or right.

Each row of images is a sequence of images belonging to each group and put in order in the row. In the example of FIG. 3, the row of the fourth group of images is scrolled.

The column (vertical direction) scrolling is performed each time the up or down key 4a is pressed, while the row (horizontal direction) scrolling is performed at a low speed at the first press of the left or right key 4b, and at a high speed at the second press of the left or right key 4b for the same direction. The row scrolling stops when the user presses the opposite (right or left) key 4b regardless of the scrolling speed. This display control is performed under the software control of the CPU 18 executing the control program.

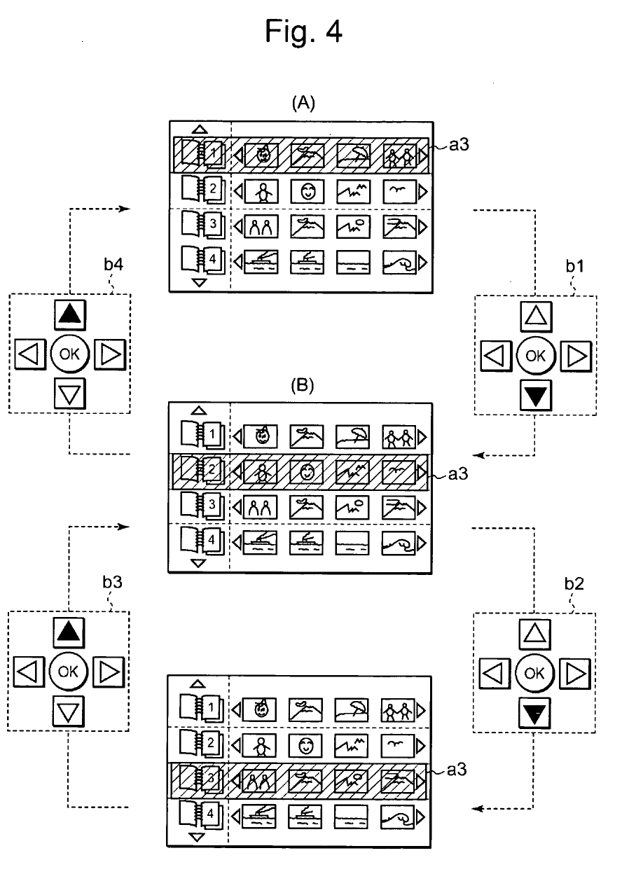

The following describes specific examples of the transition of the display screen when the camera 1 is in the album mode with reference to FIGS. 4 to 6.

Suppose that the camera 1 is now in the album mode and the screen of the display 2 is as shown (A) in FIG. 4. In other words, the images in the first to fourth groups are displayed on the screen, and the first group in the four groups is active. In this state, when the down key 4a in the XY control keys 4 is pressed (b1), the active frame moves down to make the second group active ((B) in FIG. 4).

If the down key 4a in the XY control keys 4 is pressed again in the state of (B) in FIG. 4 as shown by (b2), the active frame further moves downward to make the third group active ((C) in FIG. 4). Conversely, if the up key 4a in the XY control keys 4 is pressed in the state of (C) in FIG. 4 (C) as shown by (b3), the active frame moves upward to make the second group active, returning to the state of (B) in FIG. 4. Further, if the up key 4a in the XY control keys 4 is pressed (b4), the active frame further moves upward to make the first group active, returning to the state of (A) in FIG. 4. Thus, the user can make any group active by operating the up and down keys 4a in the XY control keys 4.

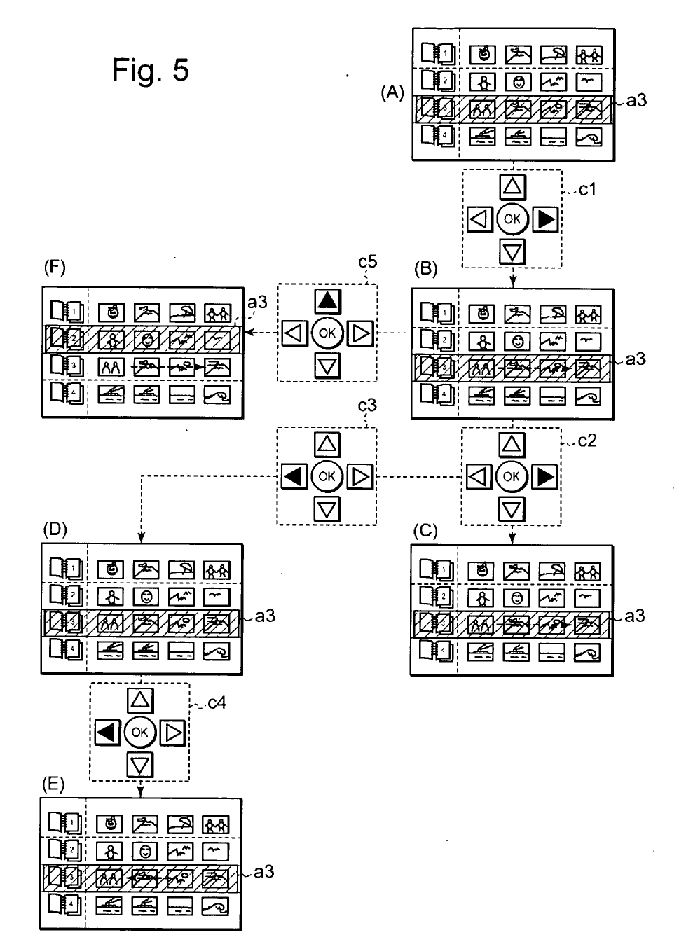

The following describes such cases that the user operates the left and right keys 4b in the XY control keys in addition to the up and down keys 4a. Suppose first that the screen of the display 2 is as shown (A) in FIG. 5. In other words, the images in the first to fourth groups are displayed on the screen, and the third group in the four groups is active.

In this state, when the right key 4a in the XY control keys 4 is pressed (c1), the images in the third group start being scrolled to the right at a low speed ((B) in FIG. 5). In other words, the images in the row changes in such a manner that the rightmost image disappears while a new image appears at the left end. If the images are arranged from the right to the left in order from the oldest to the newest, the operation allows the user to trace back and retrieve the images in the third group in chronological order.

Further, if the right key 4a in the XY control keys 4 is pressed in the state of (B) in FIG. 5 as shown by (c2), the scrolling speed becomes higher ((C) in FIG. 5). On the other hand, if the left key 4a in the XY control keys 4 is pressed in the state of (B) in FIG. 5 (c3), the scrolling stops ((D) in FIG. 5). Further, if the left key 4a in the XY control keys 4 is pressed (c4), the images in the row start being scrolled to the left at a low speed ((E) in FIG. 5). Thus, the user can retrieve the images in the third group in chronological order.

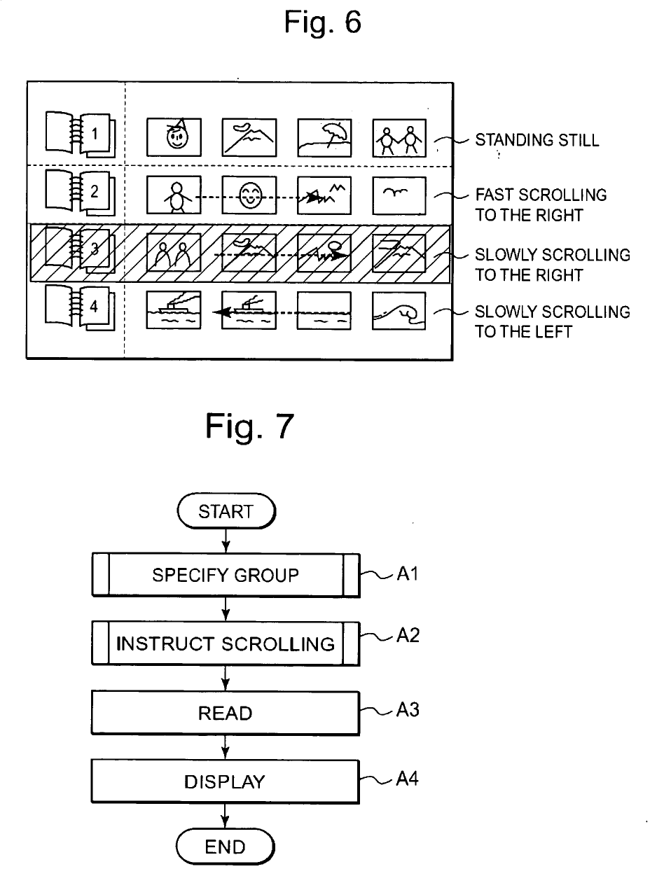

On the other hand, in the state of (B) in FIG. 5, that is, when the row of images in the third group is being scrolled to the right at the low speed, if the up key 4a in the XY control keys 4 is pressed (c5), the camera 1 moves the active frame to the second group while maintaining scrolling the images in the third group ((F) in FIG. 5). In this state, if either the left or right key 4b in the XY control keys 4 is pressed, the images in the second groups start being scrolled separately from the scrolling of the images in the third group. For example, as shown in FIG. 6, it is possible to operate the images simultaneously in such a way as to scroll the row of images in the second group to the right at the high speed, the row of images in the third group to the right at the low speed, and the row of images in the fourth group to the left at the low speed. This allows the user to retrieve the images in each group efficiently.

The following describes display control procedures when the camera 1 is in the album mode with reference to the flowcharts of FIGS. 7 to 9. FIG. 7 is a flowchart showing the flow of the main operation in the album mode.

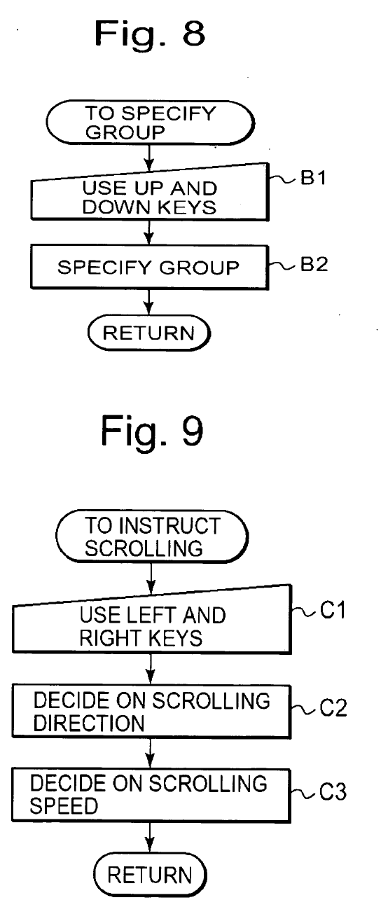

When the camera 1 is set to the album mode, the CPU 18 first executes group identification processing the detailed procedure of which is shown in FIG. 8 (step A1). In the group identification processing, the CPU 18 identifies a group to be made active (step B2) according to the operations of the up and down keys 4a (step B1) informed from the operation part 20.

After the completion of the group identification processing, the CPU 18 executes scrolling instruction processing the detailed procedure of which is shown in FIG. 9 (step A2). In the scrolling instruction processing, the CPU 18 decides on not only the scrolling direction (step C2) but also the scrolling speed (step C3) according to the operations of the left and right keys 4b (step C1) informed from the operation part 20.

After the completion of the scrolling instruction processing, the CPU 18 reads image data from the image memory 17 based on the result of the group identification processing at step A1 and the result of the scrolling instruction processing at step A2 (step A3). Then, the CPU 18 controls the display driver 14 to display the read image data on the display 2 (step A4).

As described above, the camera 1 allows the user to scroll, on a group basis, images in a plurality of groups (albums) simultaneously displayed on a screen, and hence to retrieve a target image efficiently from the image groups managed on a group basis in the camera 1.

### Second Embodiment

The following describes a display apparatus according to a second embodiment of the present invention.

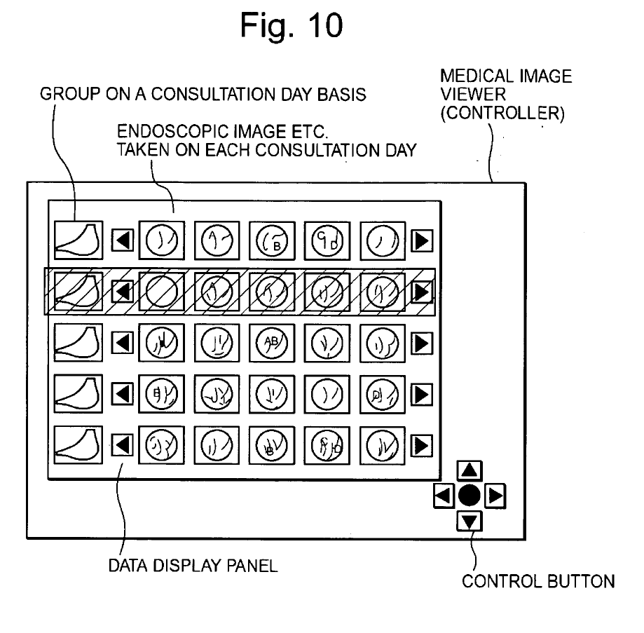

This embodiment shows an example of applying the present invention to viewing of medical images such as endoscopic images or X-ray images of an oral cavity, teeth, etc. FIG. 10 is a diagram showing a display example according to the second embodiment of the present invention. For example, a display screen is provided on the front of an image monitoring apparatus (medical image viewer) as a display apparatus. A data display panel as the display screen occupies much of the area of the front of the image monitoring apparatus, with control buttons for instructing scrolling arranged in the bottom, right-hand corner. On the screen, images of an affected part are displayed. At each hospital or medical center, patient information and consultation date information are added to each of the affected part images of each patient so that the affected part images will be grouped based on the consultation date of the patient, and stored and managed on a hard disk or the like. The following describes display control processing for displaying affected part images on a group basis.

The affected part images in FIG. 10 are images taken from the same patient on different consultation dates. In other words, images on the same consultation date form a group. On the screen, icons at the leftmost column indicate the groups. Though not shown in FIG. 10, each consultation date is superimposed on each of the icons indicating the groups. Then, the affected part images taken on each consultation date are displayed in the row following each icon in order of photographing date. Alphabets (A, B, etc.) in the affected part images are remarks checked by a doctor.

Since the detailed procedure is the same as that shown in FIG. 4, the procedure in this embodiment is described below in brief. The control buttons correspond to the switching instruction section and the selection instruction section. The control buttons are used to select a group to be scrolled, and then a scroll direction and speed, so that the affected part images in the group selected (or made active) will be scrolled in accordance with the instructions. Similarly, the images in the other groups can be scrolled or switched accordingly. Thus, the doctor can operate the control buttons to display and compare the affected part images on different consultation dates on the same screen.

Thus, the application of the present invention to a system for displaying the progress of a specific patient allows a doctor to keep track of changes in the affected part of the patient in a list format, and hence to provide an effective explanation to the patient.

The first embodiment described above assumes that the XY control keys 4 consist of the pair of up and down keys 4a and the pair of up and down keys 4a such that the selection of a group and the scrolling operation are performed using different button operations, that is, by the pair of up and down keys 4a (selection instruction section) and the pair of left and right keys 4b (switching instruction section), respectively. However, this key assignment is not an essential part of the technique of the present invention. For example, it is easy to modify the XY control keys 4 in the form of a single button operable in up, down, left, and right directions for both the group selection and the scrolling operation within the scope of the present invention.

According to the aforementioned two embodiments, the present invention can be implemented in the following forms:

1) A display apparatus comprising: a display section (display 2) for displaying images; a control section (CPU 18) for causing a plurality of groups of images to appear simultaneously on the display section on a group basis while controlling the switching of images to be displayed on the display section; a switching instruction section (left and right keys 4b) for instructing the switching of images to be displayed on the display section; and a selection instruction section (up and down keys 4a) for selecting a group from the plurality of groups displayed on the display section, wherein when the switching instruction section instructs switching, the control section switches only the images displayed as a group selected by the selection instruction section from all the images displayed on the screen in accordance with the instruction from the switching instruction section.

2) A camera (camera 1) comprising the display apparatus as set forth in the above 1) and an imaging section for forming subject images, wherein the control section causes the images formed by the imaging section appear on the display section as grouped images.

3) A display method for displaying images managed in each group on a display section, comprising: displaying a plurality of groups of images grouped and managed in each group on the same screen on a group basis, and when an instruction for switching images is accepted, only the images of the groups that is arbitrarily selected from the plurality of groups becomes the objects of the image switching in response to the instruction for switching images.

4) A computer-readable storage medium storing a program causing a computer to execute a display method for displaying images managed in each group on a display section, the display method comprising the steps of: displaying a plurality of groups of images grouped and managed in each group on the same screen on a group basis, and when an instruction for switching images is accepted, only the images of the groups that is arbitrarily selected from the plurality of groups becomes the objects of the image switching in response to the instruction for switching images.

5) A program causing a computer to execute a display method for displaying images managed in each group on a display section, the display method comprising the steps of: displaying a plurality of groups of images grouped and managed in each group on the same screen on a group basis, and when an instruction for switching images is accepted, only the images of the groups that is arbitrarily selected from the plurality of groups becomes the objects of the image switching in response to the instruction for switching images. Although the first embodiment assumes the display apparatus incorporated in a camera, the display apparatus can also be a stand-alone display apparatus.

Further, the first embodiment is described by taking the camera as an example, the control technique of the present invention can be applied to various electronic devices, such as a PDA, personal computer, cellular phone, etc.

The scope of the present invention includes such a form that a software program causing the CPU 18 to perform the above-mentioned functions is loaded to the CPU 18 so that the CPU 18 operates according to the software program to perform the functions of the aforementioned embodiments. In other words, the software program executed to perform the functions of the aforementioned embodiments constitutes the present invention.

The program can also be stored in a recording medium other than the ROM 19 and read from the recording medium. Further, the program can be stored in a removable recording medium and inserted in the camera 1. As the recording medium, an optical recording medium such as a DVD, a magnetic recording medium such as an MD, a tape medium, a semiconductor memory such as an IC card, etc. can be used as well as a floppy disks® and a CD-ROM.

Furthermore, a storage device such as a hard disk or RAM provided in a server system connected to a private communication network or the Internet can be used as the recording medium to provide a program to the camera 1 through the communication network. Even if the program cooperates with another application program to perform the functions of the aforementioned embodiments, such a program is, of course, included in the embodiments of the present invention.

In the aforementioned embodiments, the program is executed by the CPU 18 to perform the processing steps, but the present invention is not limited thereto. For example, part or all of the processing steps can be implemented via hardware.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A display apparatus comprising:
a display section for displaying images;
a control section for causing a plurality of groups of images appear simultaneously on the display section on a group basis while controlling the switching of images to be displayed on the display section;
a switching instruction section for instructing the switching of images to be displayed on the display section; and
a selection instruction section for selecting a group from the plurality of groups displayed on the display section,
wherein when the switching instruction section instructs switching, the control section switches only the images displayed as a group selected by the selection instruction section from all the images displayed on the screen in accordance with the instruction from the switching instruction section.

2. The apparatus according to claim 1, wherein the control section scrolls a row of images to switch the images in accordance with the instruction from the switching instruction section.

3. The apparatus according to claim 2, wherein the control section changes the scrolling speed in accordance with the instruction from the switching instruction section.

4. The apparatus according to claim 1, wherein when the control section is switching the images displayed as a group selected by the selection instruction section in accordance with the instruction from the switching instruction section, if the switching instruction section instructs switching in response to the selection of a new group through the selection instruction section, the control section starts the switching of images in the latter group separately from the former group while continuing the switching of images in the former group.

5. The apparatus according to claim 4, wherein the control section switches images to scroll a row of images, and controls at least either the scrolling speed or the scrolling direction independently on a group basis.

6. A camera comprising:
the display apparatus according to claim 1; and
an imaging section for forming subject images,
wherein the control section causes images formed by the imaging section to appear on the display section as grouped images.

7. A display method for displaying images managed in each group on a display section, comprising:
displaying a plurality of groups of images grouped and managed in each group on the same screen on a group basis; and
when an instruction for switching images is accepted, only the images of the groups that is arbitrarily selected from the plurality of groups becomes the objects of the image switching in response to the instruction for switching images.

8. A computer-readable storage medium storing a program causing a computer to execute a display method for displaying images managed in each group on a display section,
wherein the display method comprising the steps of: displaying a plurality of groups of images grouped and managed in each group on the same screen on a group basis, and when an instruction for switching images is accepted, only the images of the groups that is arbitrarily selected from the plurality of groups becomes the objects of the image switching in response to the instruction for switching images.
